(19) United States
(12) Patent Application Publication
(10) Pub. No.: US 2009/0312443 A1
(43) Pub. Date: Dec. 17, 2009

(54) METHOD FOR PRODUCING AQUEOUS FLUORINE-CONTAINING POLYMER DISPERSION AND AQUEOUS FLUORINE-CONTAINING POLYMER DISPERSION

(76) Inventors: Chie Sawauchi, Osaka (JP); Nobuhiko Tsuda, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 12/307,304

(22) PCT Filed: Jul. 6, 2007
(86) PCT No.: PCT/JP2007/063570

§ 371 Date: Jan. 2, 2009

(30) Foreign Application Priority Data
Jul. 7, 2006 (JP) 2006-187712

(51) Int. Cl. B01J 47/00

(52) U.S. Cl. 521/25

(57) ABSTRACT

The present invention provides a method of obtaining good aqueous fluoropolymer dispersions low in fluorinated surfactant content by efficiently removing the fluorinated surfactant through pH adjustment. The present invention is related to a method of producing an aqueous fluoropolymer dispersion comprising a contact treatment for brining a raw aqueous fluoropolymer dispersion into contact with an anion exchanger, and the contact treatment being carried out while a pH of the raw aqueous fluoropolymer dispersion is adjusted to 2 to 9.

### TECHNICAL FIELD

The present invention relates to a method of producing an aqueous fluoropolymer dispersion and to an aqueous fluoropolymer dispersion.

### BACKGROUND ART

Aqueous fluoropolymer dispersions can be molded into films, coatings and like moldings showing good characteristics such as chemical stability, nonstickiness and weathering resistance by such a technique as coating or impregnation and, therefore, are widely used in such fields of application as cooking utensils, pipe linings and impregnated glass cloths. Aqueous fluoropolymer dispersions are generally obtained by polymerization in the presence of a fluorinated surfactant. However, such fluorinated surfactant causes impairments in the good characteristics of fluoropolymers and, therefore, is desirably to be removed from the aqueous fluoropolymer dispersions. Further, the fluorinated surfactant is generally expensive and, therefore, is preferably to be recovered for reutilization.

A method of recovering fluorinated surfactants, which has been proposed, comprises bringing the aqueous fluoropolymer dispersion supplemented with a nonionic emulsifier for stabilization into contact with a basic anion exchange resin (cf. e.g. Patent Document 1). However, such method, when carried out continuously, raises a problem, namely the pH of the aqueous dispersion shifts toward alkalinity. An excessive shift of the aqueous dispersion to alkalinity retards the dissociation of the fluorinated surfactant, hence is unfavorable. Patent Document 1 indeed describes that the pH of the dispersion may be adjusted to 7 to 9 using a base to increase the stability thereof, but does not disclose any particulars.

Patent Document 2 discloses a method which comprises using an anion exchange resin in the form of a moving bed, not in a form packed in a column or the like, and bringing the aqueous fluoropolymer dispersion into contact with the same with stirring. This document does not contain any description of pH adjustment in this method, however.

### Patent Document 1: Japanese Kohyo Publication 2002-532583

### Patent Document 2: International Publication WO 03/099879

### DISCLOSURE OF INVENTION

### Problems which the Invention is to Solve

In view of the state of the art as discussed above, it is an object of the present invention to provide a method of obtaining good aqueous fluoropolymer dispersions low in fluorinated surfactant content by efficiently removing the fluorinated surfactant through pH adjustment.

### Means for Solving the Problems

The present invention provides a method of producing an aqueous fluoropolymer dispersion comprising a contact treatment for brining a raw aqueous fluoropolymer dispersion into contact with an anion exchanger, and the contact treatment being carried out while a pH of the raw aqueous fluoropolymer dispersion is adjusted to 2 to 9.

The present invention also provides an aqueous fluoropolymer dispersion which is obtained by the method of producing the aqueous fluoropolymer dispersion mentioned above.

In the following, the present invention is described in detail.

The invention relates to a method of producing an aqueous fluoropolymer dispersion efficiently deprived of the fluorinated surfactant by promoting the dissociation of the fluorinated surfactant through pH adjustment of the aqueous fluoropolymer dispersion to be treated (hereinafter referred to as “raw aqueous fluoropolymer dispersion”). The case of the use of an ammonium perfluorocarboxylate as the fluorinated surfactant is described as an example. The ammonium perfluorocarboxylate shows a dissociation equilibrium describable by the following formula.

RfCOONH₄⇄RfCOO⁻+NH₄⁺

Since the anion exchanger adsorbes RfCOO—, it is preferred that the above equilibrium reaction proceed to the right so that the removal efficiency may be raised. However, with the progress of the reducing treatment, the amount of NH₄⁺ occurring in the aqueous fluoropolymer dispersion increases and the pH thus rises, pushing the pH of the aqueous dispersion to the alkaline side, namely to about 9 to 11. As a result, there arises a problem: the equilibrium is no longer shifted toward the dissociation, with the result that the fluorinated surfactant reduction is not effected efficiently.

According to the production method of the invention, the above contact treatment is carried out while the raw aqueous fluoropolymer is adjusted pH to 2 to 9. By adjusting the pH within the above range, it becomes possible to promote the dissociation of the fluorinated surfactant and efficiently remove the fluorinated surfactant.

The method of producing an aqueous fluoropolymer dispersion according to the invention comprises the contact treatment for brining an anion exchanger and a raw aqueous fluoropolymer dispersion into contact with each other and is characterized in that the pH of the raw aqueous fluoropolymer dispersion is continuously adjusted to 2 to 9 during the above-mentioned contact treatment. At pH levels exceeding 9, the fluorinated surfactant elimination efficiency declines. When the pH is lower than 2, the stability of the raw aqueous fluoropolymer dispersion decreases and aggregation occurs. The above pH is more preferably 3 to 8.

The raw aqueous fluoropolymer dispersion mentioned above comprises a fluoropolymer dispersed in an aqueous medium.

In the practice of the invention, the fluoropolymer is not particularly restricted but includes, among others, polytetrafluoroethylene [PTFE], tetrafluoroethylene [TFE]/hexafluoropropylene [HFP] copolymers [FEPs], TFE/perfluoro(alkyl vinyl ether) [PAVE] copolymers [PFAs], ethylene/TFE copolymers [ETFEs], poly(vinylidene fluoride) [PVDF], and polychlorotrifluoroethylene [PCTFE].

The above-mentioned PTFE may be a tetrafluoroethylene [TFE] homopolymer or a modified polytetrafluoroethylene [modified PTFE]. The term “modified PTFE” as used herein means a non-melt-processable fluoropolymer obtained by polymerizing TFE and a trace amount of monomer/trace amount of monomers.

As the trace amount of monomer/trace amount of monomers, there may be mentioned, for example, such fluoroolefins as HFP, chlorotrifluoroethylene [CTFE], fluoro(alkyl vinyl ether) species whose alkyl moiety containing 1 to 5 carbon atoms, in particular 1 to 3 carbon atoms; fluorodioxoles; perfluoroalkylethylenes; and ω-hydroperfluoroolefins.

Preferred as the fluoropolymer mentioned above are perfluoropolymers; among them, TFE homopolymers and modified PTFEs are more preferred.

The aqueous fluoropolymer dispersion of the invention preferably contains dispersed fluoropolymer particles having an average primary particle diameter of 50 to 400 nm.

The average primary particle diameter is the value determined by measuring the transmittance, per unit length, of projected light at the wavelength of 550 nm through an aqueous dispersion diluted with water to a fluoropolymer concentration of 0.22% by mass and comparing the measurement result with a working curve showing the relation between the average primary particle diameter and the above transmittance as obtained in advance by measurements of diameters in a certain direction on transmission electron photomicrographs.

A raw aqueous medium in the aqueous fluoropolymer dispersion is not particularly restricted provided that it is a water-containing liquid; it may contain, in addition to water, a nonfluorinated organic solvent and/or a fluorinated organic solvent, for example an alcohol, ether, ketone or paraffin wax.

The raw aqueous fluoropolymer dispersion mentioned above may be a dispersion as polymerized without any history of concentration or dilution, or may be a dispersion obtained after concentration by phase separation or by ultrafiltration or after dilution, for instance. Further, it may be one obtained after conventional fluorinated surfactant removing treatment. Such treatment(s) may be carried out after the fluorinated surfactant elimination treatment according to the invention.

The concentration of the fluoropolymer contained in the raw aqueous fluoropolymer dispersion is not particularly restricted but preferably is not higher than 40% by mass from the fluorinated surfactant elimination efficiency viewpoint. The concentration mentioned above also applies to the case where the above-mentioned concentration, dilution or like treatment is carried out. From the concentration efficiency viewpoint, the above concentration is preferably not lower than 15% by mass.

The fluorinated surfactant mentioned above is not particularly restricted provided that it is a fluorine atom-containing surfactant; it is preferably an anionic surfactant in view of its great ability to disperse fluoropolymers.

As the above fluorinated anionic surfactant, there may be mentioned, for example, perfluorocarboxylic acids and/or salts thereof such as perfluorooctanoic acid and/or salts thereof (hereinafter “perfluorooctanoic acid and/or salts thereof” are sometimes collectively referred to as “PFOA” for short); and perfluorooctylsulfonic acid and/or salts thereof (hereinafter “perfluorooctylsulfonic acid and/or salts thereof” are sometimes collectively referred to as “PFOS” for short) and the like. Among them, a perfluorocarboxylic acid and/or a salt thereof is preferred.

In cases where the fluorinated anionic surfactant is in the form of a salt, the counter ion forming the salt is an alkali metal ion or NH₄⁺, for instance, and the alkali metal ion is, for example, Na⁺ or K⁺. NH₄⁺ is preferred as the counter ion, however. The fluorinated surfactant may comprise one single species or two or more species.

From the ready removability viewpoint, the fluorinated surfactant is preferably one having a number average molecular weight of not higher than 1000, more preferably not higher than 500; it is preferably one containing 5 to 12 carbon atoms. The number average molecular weight, so referred to herein, is the measured value on the polystyrene equivalent basis as measured by GPC (gel permeation chromatography).

The above-mentioned anion exchanger is not particularly restricted but may be, for example, such an inorganic compound as hydrotalcite or hydrocalmite, an anion exchange membrane or an anion exchange resin. Among them, an anion exchange resin is preferred. As for the contact treatment using the anion exchanger, there may be mentioned, among others, the method comprising passage through the anion exchanger packed in a column, and the method comprising direct addition to the raw aqueous fluoropolymer dispersion, followed by stirring and separation.

As the anion exchange resin, there may be mentioned those known in the art, for example strongly basic anion exchange resins having —N+X—(CH₃)₃ groups (X representing Cl or OH) as functional groups and strongly basic anion exchange resins having —N+X (CH₃)₃(C₂H₄OH) groups (X being as defined above).

The anion exchange resin preferably has a counter ion corresponding to an acid having a pKa value of not lower than 3 and is preferably used in the OH— form.

The anion exchange resin is preferably one prepared by treating the Cl form resin with a 1 M aqueous NaOH solution for conversion to the OH form, followed by sufficient washing with pure water.

The contact treatment mentioned above is not particularly restricted but the only requirement is that the anion exchanger and the raw aqueous fluoropolymer dispersion come into contact with each other. More specifically, appropriate conditions can be selected based on the conventional method known in the art, for example the method described in Japanese Kohyo Publication 2002-532583; for example, the treatment is preferably carried out in a manner such that the space velocity [SV] amounts to 0.1 to 10, preferably 0.5 to 5.

The method of adjusting the pH of the aqueous fluoropolymer dispersion during the above contact treatment is not particularly restricted but includes, among others, the method comprising treatment with a cation exchanger, the method comprising successive pH measurement using a pH meter while adding an acidic compound for pH adjustment, and the method comprising adding a buffer agent.

The acidic compound mentioned above is not particularly restricted but may be, for example, such an acid as nitric acid, perchloric acid or sulfuric acid.

Among the methods mentioned above, the method comprising treatment with a cation exchanger is particularly preferred.

When the pH adjustment is carried out by this method, surplus cations are removed, so that the efficiency in impurity content reduction in the aqueous fluoropolymer dispersion also can favorably be increased.

The above cation exchanger treatment is favorable since such cationic impurities as alkali metal ions, heavy metal ions and polymerization initiator-derived nonfluorinated organic acids can be removed. By reducing the above mentioned alkali metals, the aqueous dispersion with less coloration after the processing such as baking can be obtained. The alkali metal is not particularly restricted but includes sodium and potassium, among others.

As the heavy metal, there may be mentioned iron, chromium and nickel, among others. The reduction of heavy metal concentration in the aqueous dispersion is advantageous in that the dispersion, when used in the field of batteries, hardly causes rusting of electrodes. Examples of the nonfluorinated organic acid are formic acid, acetic acid, butyric acid, oxalic acid and succinic acid. These nonfluorinated organic acids cause corrosion of electrode metals when the dispersion is used as a binder in batteries; it is therefore desirable that the content thereof be reduced.

The cation exchanger mentioned above may be a cation exchange resin. The cation exchange resin is not particularly restricted but includes those known in the art, for example strongly acidic cation exchange resins having —SO₃⁻ groups as functional groups and weakly acidic cation exchange resins having —COO⁻ groups as functional groups. Among them, strongly acidic cation exchange resins are preferred from the removal efficiency viewpoint; H⁺ form strongly acidic cation exchange resins are more preferred.

The cation exchange resin to be used is preferably one prepared by treatment of the Na form resin with a 1 M aqueous HCl solution for conversion to the H⁺ form, followed by sufficient washing with pure water.

Use can be made, as the cation exchange resin, of such commercial products as, for example, Amberlite IRA120B Na (trade name, product of Rohm and Haas), IRA120BNNa (trade name, product of Rohm and Haas) and Amberjet IRA1006F H (trade name, product of Rohm and Haas).

As a method of carrying out the treatment with a cation exchanger, there may be mentioned the method using a mixed bed comprising the cation exchange resin and the anion exchange resin. The cation exchange resin may be used in the form packed in a column, as mentioned above for the anion exchange resin or may be directly added to the raw aqueous fluoropolymer dispersion, followed by stirring. The above-mentioned “mixed bed comprising a cation exchange resin and an anion exchange resin” is not particularly restricted but includes, among others, the case where both are packed in one and the same column, the case where both are packed in different columns, and the case where both are dispersed in the raw aqueous fluoropolymer dispersion. Thus, the mode of use is not particularly restricted but it is only required that the raw aqueous fluoropolymer dispersion be in contact with the anion exchange resin and the cation exchange resin in the contact treatment.

The ratio by volume of the cation exchange resin to the anion exchange resin in the mixed bed (hereinafter referred to as “mixing ratio of the anion/cation ion exchange resins”) is not particularly restricted provided that it is within the range within which the pH can be maintained; the ratio is preferably 0.1 to 10, more preferably 0.2 to 5.0. An increased proportion of the cation exchange resin, hence the use of the cation exchange resin in an amount more than needed, raises the cost excessively. When the proportion of the anion exchange resin is increased, the pH shifts toward the alkalinity, whereby the organic acid removing efficiency is decreased.

The ion exchange resins are used in the form uniformly dispersed in pure water, and the mixing ratio of the anion/cation ion exchange resins mentioned above is the value based on the volumes on that occasion of use. Although the ion exchange resins, once used for aqueous dispersion treatment, show changes in volume, the mixing ratio of the anion/cation ion exchange resins is defined as the value obtained from the volumes of the fresh ion exchange resins or of the ion exchange resins sufficiently washed after use.

In carrying out the production method according to the invention, it is preferred that the nonfluorinated nonionic surfactant be added to the raw aqueous fluoropolymer dispersion on the occasion of the contact treatment. The nonfluorinated nonionic surfactant contained therein can favorably contribute toward stabilizing the dispersibility of the fluoropolymer.

The nonfluorinated nonionic surfactant is not particularly restricted provided that it comprises a fluorine-free nonionic compound or compounds; thus, any of those known in the art can be used. As such nonionic surfactant, there may be mentioned, for example, ether type nonionic surfactants such as polyoxyethylene alkylphenyl ethers, polyoxyethylene alkyl ethers andpolyoxyethylenealkylene alkyl ethers; polyoxyethylene derivatives such as ethylene oxide/propylene oxide block copolymers; ester type nonionic surfactants such as sorbitan fatty acid esters, polyoxyethylenesorbitan fatty acid esters, polyoxyethylenesorbitol fatty acid esters, glycerol fatty acid esters and polyoxyethylene fatty acid esters; and amine type nonionic surfactants such as polyoxyethylenealkylamines and alkylalkanolamides.

In each compound constituting the above-mentioned nonfluorinated nonionic surfactant, the hydrophobic group may be an alkylphenol group, a straight alkyl group or a branched alkyl group but the compound is preferably one containing no benzene ring, for example a compound having no alkylphenol group in the structure thereof.

Preferred among others as the nonfluorinated nonionic surfactant are polyoxyethylene alkyl ether type nonionic surfactants. Preferred as the polyoxyethylene alkyl ether type nonionic surfactants are those comprising a polyoxyethylene alkyl ether structure whose alkyl moiety contains 10 to 20 carbon atoms; more preferred are those comprising a polyoxyethylene alkyl ether structure whose alkyl moiety contains 10 to 15 carbon atoms. The alkyl group in the above polyoxyethylene alkyl ether structure is preferably one having a branched structure.

As commercially available examples of the above-mentioned polyoxyethylene alkyl ether type nonionic surfactants, there may be mentioned Genapol X080 (product name, product of Clariant), Tergitol 9-S-15 (product name, product of Clariant), Noigen TDS-80 (product name, product of Daiichi Kogyo Seiyaku) and Leocol TD90 (product name, product of Lion Corporation), among others.

In carrying out the ion exchange treatment by adding the nonfluorinated nonionic surfactant, the level of addition of the nonfluorinated nonionic surfactant is preferably 1 to 40% by mass, more preferably 1 to 30% by mass, still more preferably 1 to 20% by mass, relative to 100% by mass of the fluoropolymer (solid matter).

The method of producing the aqueous fluoropolymer dispersion of the invention preferably includes the step of concentration according to need after the contact treatment mentioned above. The concentration can be carried out by any of the conventional methods known in the art, for example by concentration by phase separation, by ultrafiltration, or by electric concentration. In carrying out the concentration, a nonfluorinated nonionic surfactant is preferably added to the aqueous fluoropolymer dispersion. The nonfluorinated nonionic surfactant is not particularly restricted but may be any of those enumerated hereinabove. Further, a nonfluorinated anionic emulsifier and/or an electrolyte, for instance, may also be added according to need.

The aqueous fluoropolymer dispersion obtained by the method of producing the aqueous fluoropolymer dispersion of the invention also constitutes an aspect of the present invention. The aqueous fluoropolymer dispersion of the invention has a reduced fluorinated surfactant content and has excellent characteristics.

The above-mentioned aqueous fluoropolymer dispersion preferably has a fluorinated surfactant content of not higher than 1000 ppm relative to the fluoropolymer in the dispersion. By reducing the fluorinated surfactant content to a level within such range, it becomes possible to obtain good aqueous fluoropolymer dispersions without impairing the excellent characteristics thereof. The above-mentioned content is more preferably not higher than 500 ppm. The upper limit to the above content is more preferably 100 ppm, still more preferably 50 ppm, particularly preferably 30 ppm.

In a preferred mode of embodiment of the present invention, the above-mentioned fluorinated surfactant is a fluorinated anionic surfactant, and the content of the fluorinated anionic surfactant is preferably not higher than 100 ppm relative to the fluoropolymer.

The fluorinated surfactant content so referred to herein is measured by adding an equal volume of methanol to the aqueous fluoropolymer dispersion for causing coagulation, performing Soxhlet extraction and subjecting the extract to high-performance liquid chromatography [HPLC].

The aqueous fluoropolymer dispersion of the invention preferably has a fluoropolymer content of 25 to 75% by mass. Content levels lower than 25% by mass will be disadvantageous in some instances from the transportation cost viewpoint. At levels exceeding 75% by mass, the problem that the dispersion tends to coagulate may possibly arise. Preferably, the content is 30 to 70% by mass, more preferably 50 to 65% by mass.

The fluoropolymer content (P) so referred to herein is determined in the following manner. About 1 g (X) of the sample is placed in an aluminum cup with a diameter of 5 cm and dried at 100° C. for 1 hour and further dried at 300° C. for 1 hour and, based on the thus-obtained residue on heating (Z), a calculation is made as follows: P=Z/X×100 (%).

In the aqueous fluoropolymer dispersion of the invention, the nonfluorinated nonionic surfactant content is preferably 2 to 15% by mass relative to 100% by mass of the fluoropolymer in the dispersion. At content levels lower than 2% by mass, the stability may possibly be poor. Levels exceeding 15% by mass are disadvantageous from the cost viewpoint. The content is preferably 3 to 13% by mass, more preferably 4 to 10% by mass.

The nonfluorinated nonionic surfactant content (N) so referred to herein is determined in the following manner. About 1 g (X g) of the sample is placed on an aluminum cup with a diameter of 5 cm and heated at 100° C. for 1 hour, the thus-obtained reside on heating (Y g) is further heated at 300° C. for 1 hour to give a residue on heating (Z g), and a calculation is made as follows: N=[(Y−Z)/Z]×100 (%).

The aqueous fluoropolymer dispersion of the invention, when produced using the mixed bed comprising the anion exchange resin and the cation exchange resin, favorably occurs as the aqueous fluoropolymer dispersion reduced in alkali metal, nonfluorinated organic acid and heavy metal contents, among others, as mentioned hereinabove.

The alkali metal content is preferably not higher than 1 ppm, more preferably not higher than 0.5 ppm. The nonfluorinated organic acid content is preferably not higher than 100 ppm, more preferably not higher than 50 ppm.

The heavy metal content is preferably not higher than 1 ppm, more preferably not higher than 0.5 ppm.

The heavy metal content so referred to herein can be measured by the measurement method using a frameless atomic absorption spectrophotometer as described in the International Publication WO 94/28394. This method comprises incinerating an amount, predetermined depending on the metal species to be assayed, of the sample under incineration conditions including an incinerating temperature of about 400 to 1200° C. and an incineration time of at least 100 seconds, followed by absorbance measurement using a flameless atomic absorption spectrophotometer. The term “flameless atomic absorption spectrophotometer” as used herein means a spectrophotometer for the measurement method comprising heating the sample electrically to atomize the metal contained and quantitating the metal based on the absorbance of the atomized metal.

The aqueous fluoropolymer dispersion of the invention, either as such or supplemented with one or more of various additives, can be processed into coatings, cast films, impregnations and so forth.

As the fields of application of the above-mentioned aqueous fluoropolymer dispersion, there may be mentioned, for example, oven inside linings, ice-making trays, other cooking utensils, electric wires, pipes, ship bottoms, high-frequency printed circuit boards, conveyer belts and iron sole plates; fibrous base materials, woven fabrics and nonwoven fabrics, among others. The above-mentioned fibrous base materials are not particularly restricted but, for example, glass fibers, carbon fibers and aramid fibers (Kevlar (registered trademark) fibers, etc.) can be impregnated with the dispersion to give impregnated products; etc. The above-mentioned aqueous fluororesin dispersion can be processed by any of the conventional methods known in the art.

### EFFECTS OF THE INVENTION

The method of producing an aqueous fluoropolymer dispersion of the invention makes it possible to efficiently reduce the fluorinated surfactant content.

### BEST MODES FOR CARRYING OUT THE INVENTION

The following examples illustrate the present invention in further detail. These examples are, however, by no means limitative of the scope of the invention. In the examples, “part(s)” and “%” mean “part(s) by mass” and “% by mass”, respectively, unless otherwise specified.

The measurements in each example and comparative example were carried out by the methods described below.

### (1) Fluoropolymer Content (P)

About 1 g (X) portion of the sample was placed in an aluminum cup with a diameter of 5 cm and dried at 100° C. for 1 hour and further dried at 300° C. for 1 hour and, based on the thus-obtained residue on heating (Z), a calculation was made as follows: P=Z/X×100 (%)

### (2) Fluorinated Surfactant Content

The content was determined by adding an equal volume of methanol to the aqueous fluoropolymer dispersion obtained and, after performing Soxhlet extraction, subjecting the extract to high-performance liquid chromatography [HPLC] under the conditions specified below. In calculating the fluorinated surfactant content, use was made of a working curve obtained by carrying out HPLC measurements at known fluorinated surfactant concentrations using the following mobile phase and conditions.

### (Measurement Conditions)

Column: ODS-120T (4.6 ø×250 mm, product of Tosoh Corp.)
Developing solution: Acetonitrile/0.6% aqueous perchloric acid solution=1/1 (vol/vol %)
Sample size: 20 μl
Flow rate: 1.0 ml/minute
Detection wavelength: UV 210 nm
Column temperature: 40° C.

### (3) Nonfluorinated Nonionic Surfactant Content (N) in Aqueous Dispersion

About 1 g (X g) of the sample was placed in an aluminum cup with a diameter of 5 cm and heated at 100° C. for 1 hour, the thus-obtained reside on heating (Y g) was further heated at 300° C. for 1 hour to give a residue on heating (Z g), and a calculation was made as follows: N=[(Y−Z)/Z]×100 (%)

### (4) Heavy Metal Content

The sample was incinerated under incineration conditions including an incinerating temperature of about 400 to 1200° C. and an incineration time of at least 100 seconds, and the heavy metal content was then measured using a flameless atomic absorption spectrophotometer.

### (5) Sodium Concentration

The sample, if necessary after concentration, was subjected to measurement using a 3DCE capillary electrophoresis system (product of Yokogawa Hewlett Packard) under the following conditions.

Capillary column: Fused Silica, 75 μm in diameter, 56 cm in length
Buffer: Buffer solution for cation analysis
Detection: 310 nm (reference: 215 nm)

### Preparation Example 1

### Aqueous Fluoropolymer Dispersion Preparation

To an aqueous polytetrafluoroethylene [PTFE] dispersion (average primary particle diameter 240 nm, fluoropolymer content 33%) were added a nonionic surfactant (Noigen TDS-80, product of Daiichi Kogyo Seiyaku) in an amount corresponding to 5% relative to the fluoropolymer and PFOA in an amount corresponding to 2000 ppm of the fluoropolymer and, further, the fluoropolymer content was adjusted to 30% by addition of water. The aqueous fluoropolymer dispersion obtained had a pH of 3.5 at 25° C.

### Example 1

A 20-ml portion of the anion exchange resin Amberjet IRA4002OH (trade name, product of Rohm and Haas) and 5 ml of the cation exchange resin Amberlite IRA120B H (trade name, product of Rohm and Haas) (mixing ratio of the anion/cation ion exchange resins 0.25) were placed in a polyethylene cup and mixed up, with stirring, in a state dispersed in deionized water to give a mixed bed.

A 500-ml portion of the aqueous dispersion obtained in Preparation Example 1 was taken in a 1-L beaker, 19 ml of the mixed bed obtained in the above manner (out of which Amberjet IRA4002OH amounted to 15 ml) was added, and the mixture was stirred, with such intensity that would not cause coagulation, using a stirrer for 10 hours. Thereafter, the ion exchange resins were separated from the aqueous dispersion using a mesh. The aqueous dispersion obtained had a PFOA concentration of 810 ppm of the fluoropolymer and a pH of 8.0 at 25° C.

### Example 2

The anion exchange resin Amberjet IRA4002OH (20 ml) and 28 ml of the cation exchange resin Amberlite IRA120B H (mixing ratio of the anion/cation ion exchange resins 1.4) were placed in a polyethylene cup and mixed up, with stirring, in a state dispersed in deionized water to give a mixed bed.

A 500-ml portion of the aqueous dispersion obtained in Preparation Example 1 was taken in a 1-L beaker, 36 ml of the mixed bed obtained in the above manner (out of which Amberjet IRA4002OH amounted to 12 ml) was added, and the mixture was stirred, with such intensity that would not cause coagulation, using a stirrer for 10 hours. Thereafter, the ion exchange resins were separated from the aqueous dispersion using a mesh. The aqueous dispersion obtained had a PFOA concentration of 800 ppm of the fluoropolymer and a pH of 3.7 at 25° C.

### Example 3

The anion exchange resin Amberjet IRA4002OH (15 ml) and 60 ml of the cation exchange resin Amberlite IRA120B H (mixing ratio of the anion/cation ion exchange resins 4) were placed in a polyethylene cup and mixed up, with stirring, in a state dispersed in deionized water to give a mixed bed.

A 500-ml portion of the aqueous dispersion obtained in Preparation Example 1 was taken in a 1-L beaker, 75 ml of the mixed bed obtained in the above manner (out of which Amberjet IRA4002OH amounted to 15 ml) was added, and the mixture was stirred, with such intensity that would not cause coagulation, using a stirrer for 10 hours. Thereafter, the ion exchange resins were separated from the aqueous dispersion using a mesh. The aqueous dispersion obtained had a PFOA concentration of 790 ppm of the fluoropolymer and a pH of 3.7 at 25° C.

### Comparative Example 1

A 500-ml portion of the aqueous dispersion obtained in Preparation Example 1 was placed in a 1-L beaker and 12 ml of the anion exchange resin Amberjet IRA4002OH was added, followed by the same procedure as in Example 1. The aqueous dispersion obtained had a PFOA concentration of 1400 ppm of the fluoropolymer and a pH of 11.0 at 25° C.

### Preparation Example 2

To an aqueous polytetrafluoroethylene [PTFE] dispersion (average primary particle diameter 270 nm, fluoropolymer content 34%) were added a nonionic surfactant (Noigen TDS-80, product of Daiichi Kogyo Seiyaku) in an amount corresponding to 5% relative to the fluoropolymer and PFOA in an amount corresponding to 2500 ppm of the fluoropolymer and, further, the fluoropolymer content was adjusted to 30% by addition of water. The aqueous fluoropolymer dispersion obtained had a pH of 3.5 at 25° C.

### Example 4

The anion exchange resin Amberjet IRA4002OH (500 ml) and 710 ml of the cation exchange resin Amberlite IRA120B H (mixing ratio of the anion/cation ion exchange resins 1.42) were placed in a polyethylene cup and mixed up, with stirring, in a state dispersed in deionized water to give a mixed bed. A column (2 cm in diameter) was packed with 544 ml of the above mixed bed, and 544 ml of a2% aqueous solution of Noigen TDS-80 (product of Daiichi Kogyo Seiyaku) was passed through the column at [SV]=1. The aqueous PTFE dispersion obtained in Preparation Example 2 was passed through that column at [SV]=1. The aqueous dispersion obtained had a pH of 3.6 at 25° C., a PFOA concentration below the detection limit and a fluoropolymer content of 30%. The iron concentration and sodium concentration in the aqueous dispersion obtained were both below the respective detection limits.

### Comparative Example 2

A column (2 cm in diameter) was packed with 225 ml of the anion exchange resin Amberjet IRA4002OH, and 225 ml of a 2% aqueous solution of Noigen TDS-80 (product of Daiichi Kogyo Seiyaku) was passed through the column at [SV]=1. The aqueous PTFE dispersion obtained in Preparation Example 2 was passed through that column at [SV]=2. After passage of 100 ml, the PFOA concentration began to rise and arrived at 150 ppm of the fluoropolymer. At that point of time, the aqueous dispersion showed a pH of 10.8 at 25° C. and a fluoropolymer concentration of 30%. The aqueous dispersion obtained had an iron concentration of 35 ppb and a sodium concentration of 15 ppm.

### INDUSTRIAL APPLICABILITY

The aqueous fluoropolymer dispersion obtained in accordance with the invention can be suitably used in such fields of application as cooking utensils, pipe linings and glass cloth impregnation.

1. A method of producing an aqueous fluoropolymer dispersion comprising a contact treatment for bringing a raw aqueous fluoropolymer dispersion into contact with an anion exchanger, and
the contact treatment being carried out while a pH of the raw aqueous fluoropolymer dispersion is adjusted to 2 to 9.

2. The method of producing an aqueous fluoropolymer dispersion according to claim 1,
wherein, in the contact treatment, a nonfluorinated nonionic surfactant is added to the raw aqueous fluoropolymer dispersion.

3. The method of producing an aqueous fluoropolymer dispersion according to claim 1,
wherein the anion exchanger is an anion exchange resin.

4. The method of producing an aqueous fluoropolymer dispersion according to claim 3,
wherein the pH adjustment to 2 to 9 is carried out by bringing the raw aqueous fluoropolymer dispersion into contact with a cation exchange resin.

5. The method of producing an aqueous fluoropolymer dispersion according to claim 4,
wherein the contact treatment comprises treating the raw aqueous fluoropolymer dispersion with a mixed bed comprising the anion exchange resin and the cation exchange resin.

6. The method of producing an aqueous fluoropolymer dispersion according to claim 5,
wherein the mixed bed has a volume ratio of the cation exchange resin to the anion exchange resin of 0.1 to 10.

7. An aqueous fluoropolymer dispersion which is obtained by the method of producing the aqueous fluoropolymer dispersion according to claim 1.

8. The aqueous fluoropolymer dispersion according to claim 7,
wherein a fluoropolymer content is 25 to 75% by mass,
a fluorinated surfactant content is not higher than 1000 ppm relative to the fluoropolymer, and
a nonfluorinated nonionic surfactant content is 2 to 15% by mass relative to 100% by mass of the fluoropolymer.

9. The aqueous fluoropolymer dispersion according to claim 7,
wherein an alkali metal content is not higher than 1 ppm.

10. The aqueous fluoropolymer dispersion according to claim 7,
wherein a nonfluorinated organic acid content is not higher than 100 ppm.

11. The aqueous fluoropolymer dispersion according to claim 7,
wherein a heavy metal content is not higher than 1 ppm.

12. The aqueous fluoropolymer dispersion according to claim 8,
wherein the fluorinated surfactant is a fluorinated anionic surfactant, and
a content of the fluorinated anionic surfactant is not higher than 100 ppm relative to the fluoropolymer.
